(19) United States
(12) Patent Application Publication
(10) Pub. No.: US 2003/0052496 A1
(43) Pub. Date: Mar. 20, 2003

(54) Load suspension device to be hung on a hoisting cable of a hoist

(76) Inventor: Walter Zopf, Gmunden (AT)

Correspondence Address: Kurt Kelman, COLLARD & ROE, P.C., 1077 Northern Boulevard, Roslyn, NY, 11576, US

(21) Appl. No.: 10/163,850

(22) Filed: Jun. 6, 2002

(30) Foreign Application Priority Data
Sep. 18, 2001 (EP) 01890266.8

(51) Int. Cl. B66C 1/34

(52) U.S. Cl. 294/75; 294/82.3; 294/82.31

(57) ABSTRACT

A load suspension device (1), which is attachable to a hoisting cable, has a holding recess (30), which is closable by a shackle (11) on a carrier (2), for accommodating a sling means. The shackle (11) is lockable by a lock (22), which is actuated in the locking direction by a spring-loaded piston (4) guided in a hydraulic cylinder when the load is lifted. In this case, both cylindrical chambers are connected by gap between cylinder and piston (4), released by a lip seal (6) of the piston (4) which only acts in one direction. For returning the piston (4) to release the shackle (11) by the lock (22) to deposit the load, the cylindrical chambers are connected via a line (12, 13), whose flow is controllable. Advantageous embodiments of the flow control of the line (12, 13) via a remote control device and of the load suspender (1) are indicated.

### BACKGROUND INFORMATION

The present invention relates to a load suspension device according to the preamble of claim 1.

Such load suspension devices are known from Austrian Patent 347 077 B and are used in hoists and similar conveyor devices to hold load suspension means, such as sling chains or sling cables, using which a load to be transported, for example tree trunks, bales, or similar objects, may be attached to the hoisting cable or to the hoisting chain of the hoist. These load suspension devices allow automatic opening of the shackle when the load is deposited, due to a return spring which may move, in the unlocking direction, the lock for locking the shackle which fixes the suspension means in the holding recess, unlocking of the shackle during a brief load alleviation in the course of the transport being prevented due to the line, whose flow is controllable and which is implemented in this case as a choke line activatable in the case of load alleviation, for the hydraulic medium which flows from one cylindrical chamber into the other due to the displacement movement of the piston carrying the lock. However, the choke line and the overflow channel run inside the piston and an intrinsic return valve must ensure the overflow channel is blocked in the event of a cylinder displacement in the unlocking direction of the shackle, which causes a significant production outlay.

In addition, the return spring is positioned in one of the cylindrical chambers filled with hydraulic medium and the adjustment needle provided for adjusting the flow cross-section of the choke line must be kept accessible, so that difficulties in sealing may occur and the danger of contamination and therefore malfunction exists.

According to German Patent Application 39 38 364 A, a choke line is positioned in the carrier body, however, this device operates using two different springs for the piston and the locking device and the actuation device is equipped with two crank guides, which are used via a fork guide of the main piston, depending on the setting direction. For final release of the hook or other load suspender, the load must be briefly lifted again after it is deposited in order to bring the second crank guide into effect to release the hook or other load suspender, which may be folded around a transverse axis.

A load suspension device is known from U.S. Pat. No. 5,178,427 A in which a load hook, provided in place of a shackle, remains in its position and a load shedder is provided which is adjustable in relation to the hook. This load shedder is actuated via a working piston, which is impinged upon from the main piston via a choke line.

### SUMMARY OF THE INVENTION

The present invention therefore has the object of providing a load suspension device of the type initially described which is largely maintenance-free and reliable with a comparatively low production outlay and is distinguished by its closed, compact, and robust instruction. A partial object of the invention is to provide devices in order to allow release of unlocking even if the load still partially hangs on the load suspension device or, in contrast, to prevent automatic release if the load is only briefly deposited and then conveyed further or is to be secured still hanging on the load suspender. Finally, possibilities for using the load suspension device with various sling means and devices which ease handling are to be provhich are tailored to the respective intended use.

The main object is completely achieved by the features of claim 1.

By using the annular gap between the piston and the cylinder in combination with a single-action piston seal as an overflow channel, an additional physical implementation of this overflow channel in the carrier body may be dispensed with, since the single-action piston seal leaves a relative cylinder displacement in the direction of shackle locking unimpaired due to the piston seal, which is inactive in this direction, and only prevents cylinder displacement in the opposite direction, during which the piston seal seals the overflow channel and forces the hydraulic medium to flow from cylindrical chamber to cylindrical chamber through the line, which is released if necessary, which correspondingly delays the relative movement between cylinder and piston. If the shackle, and therefore the carrier, are loaded again via the sling means before the shackle is completely unlocked, the lock penetrates fully into the catch recess due to the cylinder displacement, which is now again unimpeded in the locking direction, so that a repeated brief load alleviation also does not cause opening. Only depositing the load for a sufficiently long time when the line, whose flow is controllable, is open causes opening of the shackle through the action of the return spring, in spite of the delay of the unlocking movement through possible choking of the flow, through which the load is automatically released.

Due to the special arrangement and housing of the return spring according to claim 2, the carrier may be constructed more compactly and there is no contamination of the hydraulic medium, which causes occurrences of wear. In addition, the piston remains free of additional lines, so that there are no leakage problems to fear and a load suspension device which is well closed per se and maintenance-free and reliable results.

In an embodiment according to claim 3, the shackle is automatically brought into an open position after being unlocked, which produces an immediate release and causes the sling means to automatically fall out of the holding recess.

On the other hand, it may sometimes be desirable to secure the sling means even before raising and/or depositing the load, so that it may only be attached and/or removed by hand, with opening of the shackle nonetheless being reliably prevented when the sling means is loaded. This is ensured by an embodiment according to claim 4, the snap holder securing the sling means, but nonetheless able to be open and closed easily by hand when the load is deposited. Currently, the construction according to claim 5 is preferred for this embodiment.

A refinement according to claim 6 is used to achieve a further partial object.

According to one of the possible variants, the entire procedure of depositing the load is only controlled via the remote control device. Such a way of proceeding is advisable if, for example, during girder erection in construction using preassembled units, the girder must be held on the load suspension device until it is fixed on the holding parts and the chain or the other holding means is only to be released when the girder is secured. In addition, however, the possibility exists here of initiating the depositing of the load via a choke device automatically with a delay and then accelerating it by actuating the remote control device.

Instead of an intrinsic choke line, an embodiment according to claim 7 may be selected for the latter possibility.

To increase operational reliability and ease the loading work, one may, according to one refinement, also select the embodiment according to claim 8.

In the design according to the present invention, piston and lock are not subjected to any significant stresses. It is therefore possible in principle to use essentially unchanging parts of this type, which are suitable for various heavy loads, for load suspension devices. Care must only be taken that the stability of the suspension and hanging devices and of the holder for the sling means corresponds to the load to be suspended. This may be achieved using installed and/or replacement parts on a basic device, one possibility for various sling means being indicated in claim 9.

### BRIEF DESCRIPTION OF THE DRAWING

Further advantages of the object of the present invention may be inferred from the following description of the drawing. An example of the object of the present invention is illustrated in the drawing.

FIG. 1 shows a load suspension device according to the present invention in a diagram viewed from the side of the shackle,

FIG. 2 shows the load suspension device shown in FIG. 1, also in a diagram, from the rear,

FIG. 3 shows a diagram of the load suspension device, with the side wall removed, viewed from the valve side,

FIG. 4 shows a simplified illustration of a section through the essential parts of the load suspension device,

FIG. 5 shows a longitudinal section through the housing with the essential parts of the holding and locking device, the parts accommodated in the housing itself being left out for better visibility, and

FIGS. 6-9 show, as illustrated in FIG. 5, a holding and locking device for a differently shaped sling means in the different phases during insertion of the sling means, preliminary fixing, holding with the lock inserted, and release after unlocking.

### DETAILED DESCRIPTION OF THE EMBODIMENTS

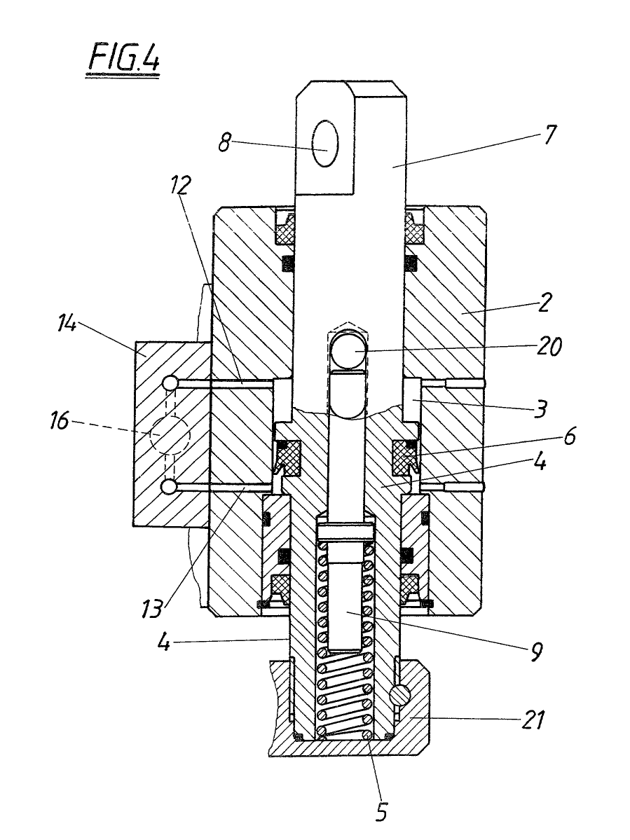

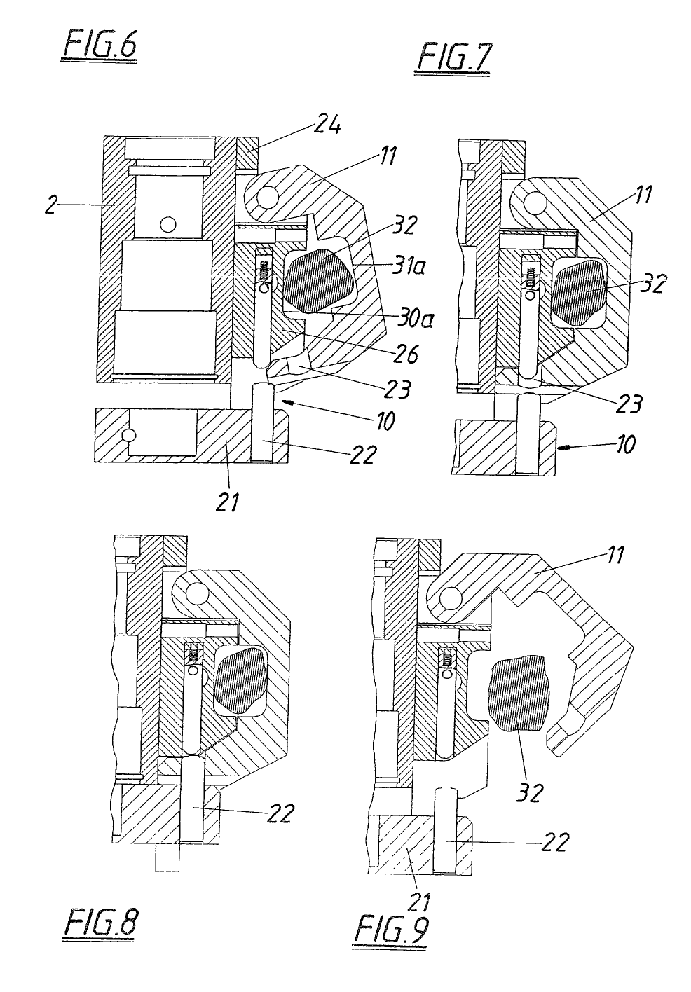

Load suspension device 1 has a carrier body 2, accommodated in a protective housing, which contains a cylindrical chamber 3 in which a piston 4 is adjustably affixed against a return spring 5, the piston sealing on the cylinder wall via a lip seal 6, which is only active in one direction. Piston rod 7 is led out sealed and has a suspension opening 8, using which the load suspension device may be attached to a cable or a chain. An inner piston 9, loaded by spring 5, is provided in piston 4, which operates a locking unit 10 for a shackle 11 via an actuator, which will be described in more detail in connection with FIGS. 4-9, so that shackle 11 is locked when piston rod 7 is pulled out, but is released when piston rod 7 is inserted.

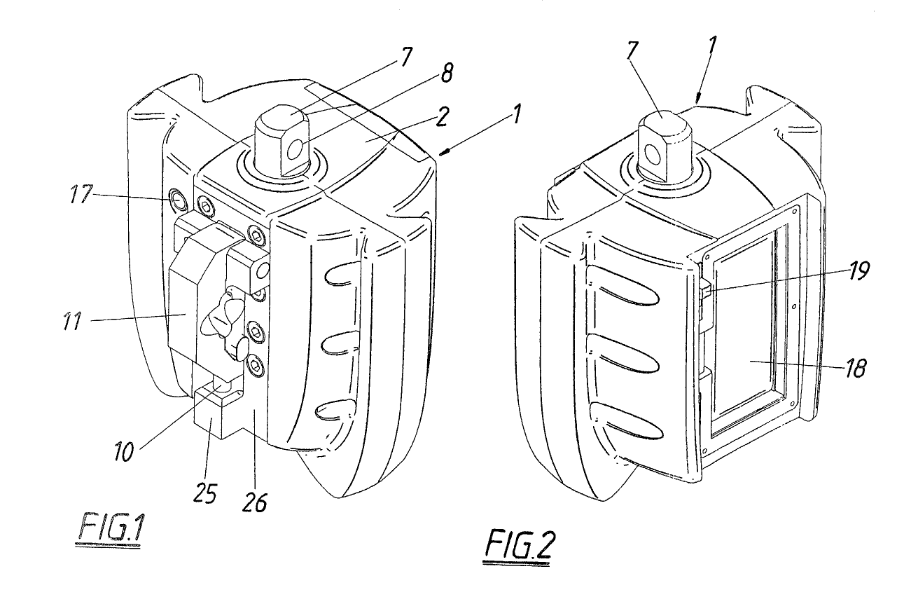

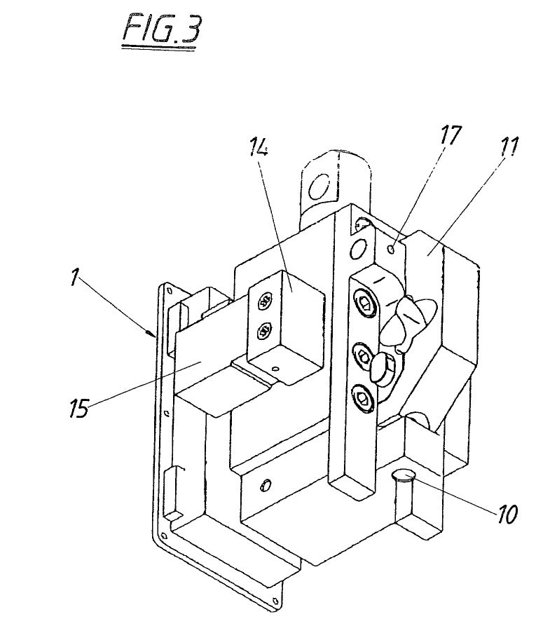

On both sides of piston 6, connection borings 12, 13 lead out of the cylindrical chambers, which are separated by the piston, into an intermediate flange 14, which, in a housing 15, a valve 16 adjoins, which is only indicated in FIG. 4 with dashes. This valve 16 is operable via control magnets accommodated in housing 15. The receiver of a radio remote control, for which a transmitter implemented as a handheld device is provided, is seated on the external housing. A battery 18 which is accommodated in a compartment (FIG. 2) is used to power the magnets accommodated in housing 15. Furthermore, there is an LED display 17 on the housing, via which the actual switching on of the magnets and therefore the opening of valve 16 is acknowledged for the user. If this display does not extinguish after the transmitted order to open valve 16, this indicates a possible fault which is to be repaired before the next use of the load suspension device.

When valve 16 is blocked, piston 4, located in the drawn out final position (right final position in FIG. 4), is fixed due to lip seal 6, which has become active. This fixing is maintained even if the load on shackle 11 is reduced or ended. If valve 16 is opened, piston 4 may readjust in the event of a change in load, so that locking pin 10 may be removed and shackle 11 may be opened. Valve 16 in housing 15 may also be actuated via a hand switch 19.

It would also be possible to additionally connect both lines 12, 13 via a choke line, so that shackle 11 is automatically released according to the choke when the loading is ended. According to another variant, piston 4 is sealed in the cylinder via a seal which is active in both directions and there is a return valve, which prevents the backflow of the hydraulic medium if piston 4 is located in the right position, in the additional line mentioned, which connects lines 12, 13. Returning to FIGS. 4-9, inner piston 9 supports itself in the inside of part 7 on a transverse pin 20 and presses against a retaining part 21 screwed onto piston 4, which projects laterally and carries a lock 22, which is intended to engage in a retaining bore 23 of shackle 11.

Shackle 11 is mounted in a support plate 24, which is replaceably attached to housing 1 using screws and whose lower region 25 encloses and/or forms a lateral guide for the projecting end of part 21 and lock 22. Support plate 24 also contains a shaped piece 26, in which a lengthwise bore 27 is provided as a guide for a spring-loaded catch pin 28. This catch pin engages in bore 23 when lock 22 is extended and therefore temporarily holds shackle 11 in the fixed position. Pin 28 may be raised via laterally projecting operating pins and secured in the retracted position by an additional catch if temporary fixing of shackle 11 is not necessary and/or desired. In this position, a repelling spring accommodated in a further bore 29 may push shackle 11 into the open position when lock 22 is open.

Lock 12 and shaped piece 26 have recesses 30, 31, which complete one another and which allow the hanging of a link chain in the embodiment shown in FIG. 5.

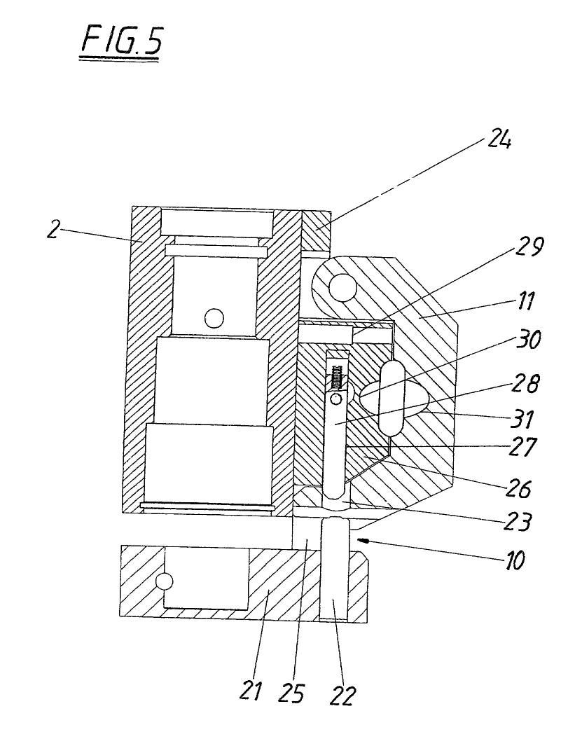

The embodiment according to FIGS. 6-9 differs from that in FIG. 5 in that recesses 30a, 31a of lock 11 and shaped piece 26 are tailored to the cross-sectional outline shape of a round sling 32.

In the position shown in FIG. 6, this round sling 32 was temporarily inserted between recesses 30a, 31a, i.e., in the receiver of the load suspension device. If lock 11 is now pivoted into the position shown in FIG. 7 while bolt 28 is unsecured, bolt 28 enters bore 23 and secures round sling 32 until the load hanging on it is actually lifted. Upon this raising, lock 22 enters bore 23 and presses bolt 28 upward, so that it may possibly be fixed in this position by a catch.

If the load is now deposited and the line connecting the cylindrical chambers is released, part 21 sinks with lock 22 into the position shown in FIG. 9 and hook 11 may be opened, as illustrated, while releasing cable sling 32.

What is claimed is:

1. A load suspension device to be hung on a hoisting cable of a hoist, having a holding recess (30) for insertion of a sling means, such as a sling chain, and a pivotable carrier (2), which closes the holding recess (30) and which has a shackle (11) lockable in the closed position by a lock (21) insertable in a catch recess, which forms a cylinder (3), filled with hydraulic medium, for a piston (4) hangable on one end on the hoist cable and provided on the other end with the lock, and which is displaceable under load by the load weight in relation to the piston against the force of a return spring (5) in the direction of locking of the shackle (11), a line (12, 13), which connects the cylindrical chambers on both sides of a piston seal to one another and whose flow is controllable, and an overflow channel, connected in parallel, which is blockable in the event of a cylinder displacement in the unlocking direction of the shackle (11), being provided,
wherein an annular gap, which is blockable by a single-action piston seal (6), between piston (4) and cylinder (2) is used as the overflow channel, and the return spring (5) is seated in a receiver bore of the piston (4) which is closed by the lock (22), attached to the piston end using an attachment leg (21) and engaging in the catch recess of the shackle in the blocking position.

2. The load suspension device according to claim 1,
wherein the return spring (5) is supported on the attachment leg (21) of the lock (22) and on an inner piston (9), engaging in the receiver bore, which is connected to the carrier (2) via a transverse bolt (20), guided in lengthwise slots (23) of the piston (15) and mounted in the carrier body (13), so that they move together.

3. The load suspension device according to claim 1 or 2,
wherein an opening spring is clamped between carrier (2) and shackle (11).

4. The load suspension device according to one of claims 1 to 3,
wherein a snap holder (23, 28) is provided for the shackle (11), which fixes it in the closed position before the lock (22) engages.

5. The load suspension device according to claim 4,
wherein the catch recess of the shackle (11) is implemented as a through bore (23), in which a spring-loaded bolt (28), which forms the snap holder and is guided in the housing and which pushes the inserted lock (22) out of the bore (23), engages before the lock (22) engages.

6. The load suspension device according to one of claims 1 to 5,
wherein a valve (14, 16) which blocks a connection line (12, 13) for the two cylindrical chambers is operable via a remote control device, particularly a radio or infrared remote control device having a transmitter and a receiver attached to the load suspension device (1), or a return or choke valve provided in the connection line is bypassed by a secondary line using a valve operable via the remote control device, an LED display (17) preferably being provided which acknowledges the control command.

7. The load suspension device according to claim 6,
wherein the valve (16) blocking the connection line is adjustable into two open positions via the remote control device (14, 19), the first of which chokes the flow and the second of which releases the flow.

8. The load suspension device according to claim 6 or 7,
wherein the valve (16) blocking the connection line, in addition to actuation via the remote control device (14, 17), is operable via a switch (19) attached to the load suspension device.

9. The load suspension device according to one of claims 1 to 8,
wherein at least the holding recess (30) and the shackle (11) are provided in and/or on a module (24) replaceably attachable to the carrier (2), so that modules tailored to differently shaped and/or implemented sling means, e.g. links or link chains, wire or hemp cables (32) and their slings and/or thickenings or clevis eyelets may be alternately used.
